(19) United States
(12) Patent Application Publication
(10) Pub. No.: US 2023/0222526 A1
(43) Pub. Date: Jul. 13, 2023

(54) OPTIMIZATION OF TIMELINE OF EVENTS FOR PRODUCT-LOCATION PAIRS

(71) Applicant: SAP SE, Walldorf (DE)

(72) Inventors: Foad Mahdavi Pajouh, Braintree, MA (US); Gustavo Ayres de Castro, Irvine, CA (US); Pedro Luis Miranda Lugo, Montreal (CA); Michael Campbell, Anaheim, CA (US); Peter Colligan, Ladera Ranch, CA (US)

(21) Appl. No.: 17/570,888

(22) Filed: Jan. 7, 2022

(51) Int. Cl. G06Q 30/02; G06N 5/00

(52) U.S. Cl. CPC G06Q 30/0202; G06Q 30/0211; G06N 5/003

(57) ABSTRACT

Computer-readable media, methods, and systems are disclosed for electronically creating an improved timeline of events for product-location pairs. A machine learning model is trained on historical data to generate a demand forecast. Input requirements including an initial timeline of events for product-location pairs are received. Using combinatorial branch-and-bound along with the trained machine learning model, the improved timeline of events for product-location pairs is generated.

### BACKGROUND

Companies across all industries use events to promote their goods. Events may include marketing techniques which are aimed at increasing the demand for products in retail stores. These marketing techniques, or tactics, may include a variety of event parameters such as special pricing, such as a temporary price reduction, display fixtures, demonstrations, value-added bonuses, no-obligation gifts, in-store flyers, newspaper inserts, general printed media, and other media.

Problems exist with determining the success of events. The success of events can be difficult to determine because there are a variety of confounding factors other than the events which may have a significant impact on the outcome. Because the impact of events are difficult to determine, companies are often unable to properly forecast event outcomes, thus making scheduling of events challenging. Many companies will simply repeat prior events without knowing the efficacy of such events. This challenge is increased exponentially when additional options for products, locations, and events are considered.

### SUMMARY

Disclosed embodiments of the present technology solve the above-mentioned problems by providing systems, methods, and computer-readable media for using a machine learning model to accurately forecast demand for potential events and a combinatorial branch-and-bound optimization approach to find an improved timeline of events for product-location pairs. The improved timeline of events for product-location pairs will be the set of products, locations, events, and event parameters over time which maximizes an objective function, for example maximizing an outcome of the timeline of events, while respecting business constraints such as budget limitations, execution limitations, key performance indicator (KPI) targets, and others.

A first embodiment is directed to one or more non-transitory computer-readable media storing computer-executable instructions that, when executed by a processor, perform a method for creating an improved timeline of events for product-location pairs, the method comprising receiving time series historical data comprising information on a plurality of past products, past locations, past event parameters, past events, and past outcomes of the events, training a machine learning model to generate a demand forecast based on the historical data, receiving input requirements comprising a set of available time periods, a set of product-location pairs, wherein each product-location pair includes a set of possible events for the product-location pair and a set of possible event parameters, an initial timeline of events for the product-location pairs comprising an initial event parameter and an initial one or more events for each product-location pair for each available time period, an objective function, and using combinatorial branch-and-bound, generating the improved timeline of events for the product-location pairs by determining, for each available time period, an event parameter and one or more events for each product-location pair such that the improved timeline of events is feasible and maximizes the objective function based on applying the machine learning model to the improved timeline of events.

A second embodiment is directed to a method for creating an improved timeline of events for product-location pairs, the method comprising receiving time series historical data comprising information on a plurality of past products, past locations, past event parameters, past events, and past outcomes of the events, training a machine learning model to generate a demand forecast based on the historical data, receiving input requirements comprising a set of available time periods, a set of product-location pairs, wherein each product-location pair includes a set of possible events for the product-location pair and a set of possible event parameters, an initial timeline of events for the product-location pairs comprising an initial event parameter and an initial one or more events for each product-location pair for each available time period, an objective function, and using combinatorial branch-and-bound, generating the improved timeline of events for the product-location pairs by determining, for each available time period, an event parameter and one or more events for each product-location pair such that the improved timeline of events is feasible and maximizes the objective function based on applying the machine learning model to the improved timeline of events.

A third embodiment is directed to a system comprising at least one data processor and at least one non-transitory memory storing computer executable instructions that when executed by the at least one data processor cause the system to carry out actions comprising receiving time series historical data comprising information on a plurality of past products, past locations, past event parameters, past events, and past outcomes of the events, training a machine learning model to generate a demand forecast based on the historical data, receiving input requirements comprising a set of available time periods, a set of product-location pairs, wherein each product-location pair includes a set of possible events for the product-location pair and a set of possible event parameters, an initial timeline of events for the product-location pairs comprising an initial event parameter and an initial one or more events for each product-location pair for each available time period, an objective function, and using combinatorial branch-and-bound, generating the improved timeline of events for the product-location pairs by determining, for each available time period, an event parameter and one or more events for each product-location pair such that the improved timeline of events is feasible and maximizes the objective function based on applying the machine learning model to the improved timeline of events.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1 depicts a method for generating an improved timeline of events for product-location pairs;

FIG. 2 depicts a combinatorial branch-and-bound method;

FIG. 3 depicts a method for branching within a combinatorial branch-and-bound method;

FIG. 4 depicts an exemplary embodiment; and

FIG. 5 depicts an exemplary hardware platform for embodiments.

The drawing figures do not limit the scope of the present claims to the specific embodiments disclosed and described herein. The drawings are not necessarily to scale, emphasis instead being placed upon clearly illustrating the principles of the present teachings.

### DETAILED DESCRIPTION

The following detailed description references the accompanying drawings that illustrate specific embodiments in which the present teachings may be practiced. The embodiments are intended to describe aspects of the present teachings in sufficient detail to enable those skilled in the art to practice the present teachings. Other embodiments can be utilized, and changes can be made without departing from the scope of the claims. The following detailed description is, therefore, not to be taken in a limiting sense. The scope of the claims is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Embodiments are contemplated where an improved timeline of events for product-location pairs is generated from an initial timeline of events for product-location pairs and other inputs defining the possible times, goods, locations or accounts, and events, as well as an objective function for which the improved timeline of events for product-location pairs should maximize. Combinatorial branch-and-bound is used to determine the optimal solution by converting the combinatorial problem into a search tree containing a plurality of nodes. Using branch-and-bound allows the optimal solution to be determined without having to try every possible solution because the bounding can remove, or fathom, nodes which are either infeasible or will not result in an optimal solution. On the branching step, the algorithm traverses down the search tree. The algorithm selects nodes for inspection, determines the node's feasibility, and estimates an upper bound to the objective function for any solution in a subtree that starts at that node. If this upper bound is less than the current best known solution it is impossible for any leaf node under that node to contain a solution that improves the current best known solution and therefore that node and its subtree can be fathomed from the search, greatly speeding-up the search. The evaluation of the estimated upper bound to the objective function for a node can be determined using a machine learning model which has been trained on data related to the outcome of prior events. This machine learning model can forecast the demand for a node. By using the trained machine learning model in combination with branch-and-bound, an improved timeline of events for product-location pairs can be efficiently generated.

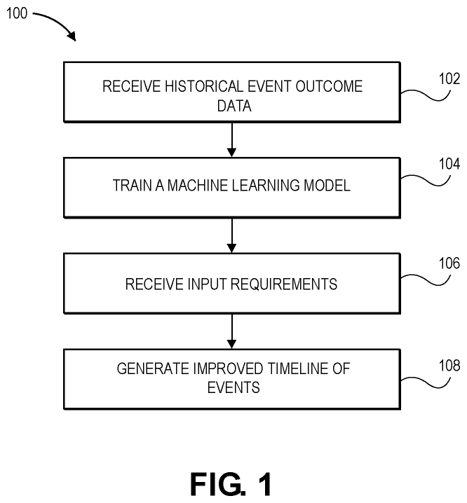

Turning first to FIG. 1, method 100 for generating an improved timeline of events for product-location pairs is disclosed. In some embodiments, the method may be performed by one or more processors that are configured to cause a computer system to carry out certain actions on the product-location pairs. In further embodiments the method may be performed on a computer. At step 102, historical event outcome data is received, which may correspond to historical sales data. In some embodiments, the historical sales data may include a list of past products, locations, event parameters, events, and sales. As used herein, a product may include instances where the product is a service. A product or service may be any products, goods, or services, either abstract or physical. In further embodiments, the historical sales data may further include information related to a cost of the products. The historical sales data may be time series data. In some embodiments, the historical sales data may come from retail stores, including from one or more point-of-sale devices. In further embodiments, the historical sales data may be syndicated data from a national data provider or from a business service provider.

At step 104, a machine learning model is trained on the event outcome data. The machine learning model may be trained to generate a demand forecast. In some embodiments, the demand forecast refers to a quantity of units of the products sold in a particular time period. In further embodiments, the machine learning model may be a non-linear regression model fitted with a Bayesian statistical process. In even further embodiments, the machine learning model may be a neural network or another artificial intelligence model. The demand forecast may be represented as a mathematical expression that provides a predicted or anticipated outcome. For example, the demand forecast may generate expected sales demand for one or more products based on the proposed event parameter, events, time, location, and other attributes of the one or more products. In some embodiments, the machine learning model may consider seasonality, the effect of other similar products, and how specific events may affect the demand forecast. In further embodiments, the machine learning model may consider the cannibalization effect between products. For example, an increase in sales in one product may lead to a decrease in sales in another product.

At step 106, input requirements are received. In some embodiments, the input requirements may include a set of available time periods. The input requirements may also include a set of product-location pairs, wherein each product-location pair includes a set of possible events for the product-location pair and a set of possible event parameters for the product-location pair. In some embodiments, the input requirements may also include a cost for each possible event. In further embodiments, the input requirements may further include an initial timeline of events for product-location pairs comprising an initial event parameter and an initial one or more events for each product-location pair for each available time period. In still further embodiments, one or more of the initial event parameters or the initial events in the initial timeline of events for product-location pairs may be locked and unable to be altered. The input requirements may further include an objective function, such as maximizing the outcome of the timeline of events. For example, the objective function may be to maximize profits, volume of sales, total revenue, or any other metric. In some embodiments, the input requirements may further include a minimum or maximum event duration, a minimum or maximum break duration, a minimum or maximum number of events, promotions, or tactics, a minimum or maximum number of event time steps, and/or an indication of whether or not events should be exclusively defined within a time step. In further embodiments, each product is assigned to a specific product group.

At step 108, an improved timeline of events for product-location pairs is generated. In some embodiments, the improved timeline of events for product-location pairs is generated using a combinatorial branch-and-bound method by converting the problem into a search tree. A combinatorial branch-and-bound method allows for the optimal timeline of events for product-location pairs to be determined without needing to try every possible combination. Without efficient bounding in a branch-and-bound method, such a problem devolves into searching the entire search tree, which is exponentially difficult—even relatively small problems with less than 100 products can generate more combinations than the number of atoms in the universe (˜10⁸⁰). Therefore, even if a method checked 10⁶² alternatives per second, checking all alternatives in such problems would potentially take billions of years, and in any case, far too long to be of present use. Efficient bounds makes good feasible solutions or even the optimal solution computable within a reasonable timeframe. In some embodiments, the branch-and-bound method may use the demand forecast to accurately determine the value at each node within the search tree with regards to the objective function.

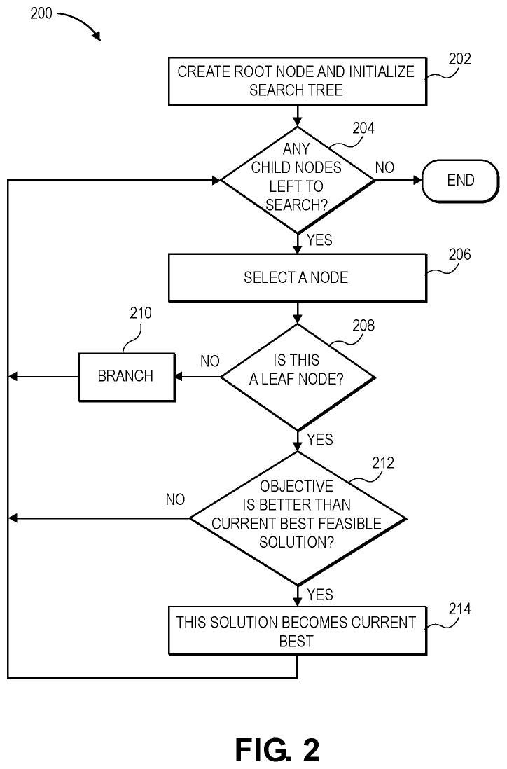

Turning to FIG. 2, method 200 depicts a combinatorial branch-and-bound method for generating an improved timeline of events for product-location pairs. At step 202, a root node is created and the search tree is initialized. In some embodiments, the root node may be created based on an initial timeline of events for product-location pairs. The initial timeline of events for product-location pairs may be checked to confirm that it is feasible. In some embodiments, the branch-and-bound algorithm may only work if the initial timeline of events for product-location pairs is feasible, otherwise the initial timeline of events for product-location pairs may be modified to become feasible. In further embodiments, the initial timeline of events for product-location pairs may be modified until it is feasible prior to a root node being created. In even further embodiments, once the root node is created, it will be assigned a node counter and the search tree will be initialized.

At step 204, a check is conducted to determine if there are any child nodes left to search. In some embodiments, the search will have been completed when all of the nodes have either been fathomed or expanded. If the search has been completed, the process will end. Otherwise, if the search has not been completed, the branch-and-bound method will iterate until the search is finalized. At the first step of the iteration, step 206, a node within the search tree is selected as the current node. In some embodiments, this node may then be removed from the search tree. In some other embodiments, multiple nodes may be selected and worked on in parallel with a scheme for information exchange between all the parallel processes reducing the overall processing time.

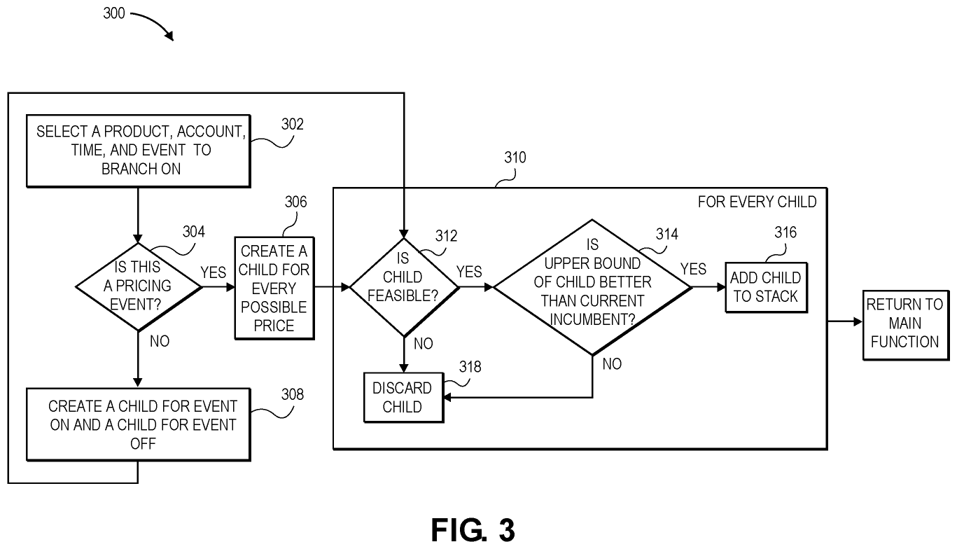

At step 208, it is determined whether or not the selected node is a leaf node. If the selected node is not a leaf node it means the node still has children that need to be branched. Thus, the method proceeds to step 210 so that a branching algorithm can be executed. An exemplary branching algorithm is disclosed at FIG. 3, although any suitable branching algorithm can be used. If the selected node is a leaf node, it means that there are no more children to expand and the method proceeds to step 212.

At step 212, the node's objective function is compared to the current best feasible solution. Because the node is a leaf node, all variables are known and so the true value of the objective function for the node can be determined. For example, if the objective function was to maximize profit, the total profit for a full timeline of events for product-location pairs could be calculated and compared to the previous best value for total profit. If this node's solution is better than the current best feasible solution, the method advances to step 214 and the selected node's solution becomes the new current best feasible solution. The method then returns to step 204 to ensure that all possible solutions are considered. Thus, in some embodiments when the method ends the optimal timeline of events for product-location pairs which maximizes the objective function will have been set as the current best feasible solution.

At any point in the execution the algorithm can be stopped, and the user would be provided the current best feasible solution, which may not be the optimal solution but is guaranteed to be either the same or better than the initial plan. In some embodiments multiple parallel versions of the algorithm may be running with different branching and search strategies, wherein each version would provide candidate solutions which would then be compared to determine an overall best solution.

Turning to FIG. 3, method 300 depicts an exemplary branching method within a combinatorial branch-and-bound method. The branching method expands out a node by determining all of the node's children which are both feasible and have a maximum upper bound which exceeds the current best feasible solution. At step 302, a product, account, time, and event for the currently selected node are selected. This selected product, account, time, and event correspond to the node which will be branched. In some embodiments, a location may be used instead of an account. Once the product, account, time, and event are selected, the method proceeds to step 304.

At step 304, it is determined whether or not the event is multi-valued event, such as a pricing event. In some embodiments, a pricing event may indicate that the price is being temporarily lowered for a sale, although any price reduction or price increase may also function as a pricing event. If the event is a pricing event, the method proceeds to step 306. Otherwise, if the event is any Boolean-valued event, such as display fixtures, demonstrations, value-added bonuses, no-obligation gifts, in-store flyers, newspaper inserts, general printed media, and other media, the method proceeds to step 308.

In some embodiments, at step 306 a child node is created for every possible price for the pricing event. This may be based on a predetermined range of available discounts. For example, a child may be created for every price between the current price and the product being sold at a 50% discount. In some embodiments, every possible price includes every discrete price between an upper and lower price bound. In further embodiments, the possible prices may be in ten cent increments, dollar increments, or some other value. In even further embodiments, the possible prices may be determined based on percent. For example, the possible prices may be 10%, 20%, and 30% off of the current price. In some embodiments, the optimal price may be determined in a single step, such as from an outside algorithm or prediction module. For example, a separate pricing program may determine that for a given product, account, and time, the optimal price is always 25% off. In other embodiments, the possible prices may lie on continuous intervals, allowed to assume any value between minimum and maximum values. The children created at step 306 proceed to sub-method 310, which iterates for all of the children created.

At step 308, two children are created for the Boolean-valued event. The first child node is the product, account, and time where the event is turned off. For example, the node may represent not offering a demonstration. The second child is the product, account, and time where the event is turned on. This child corresponds to the event being employed. For example, the node may represent offering a demonstration. This allows the algorithm to consider both situations for any individual event. Once both children are created, the method proceeds to sub-method 310.

Sub-method 310 iterates through every child created at either step 306 or step 308. The purpose of sub-method 310 is to check the feasibility and upper bounds for every child created such that children that are not feasible or which could not possibly be the optimum solution are discarded, allowing the method to save time by not fully branching nodes when not necessary. The first step of sub-method 310 is step 312 which determines if the child node is feasible. If the child node is not feasible, meaning that the child node is impossible in the timeline of events for product-location pairs, then the method proceeds to step 318 and the node is discarded. In some embodiments, the node may make one or more of the constraints of the timeline of events for product-location pairs impossible. For example, a solution may have a better outcome for the timeline of events than the current best feasible solution, but be not feasible because it requires the company to allocate more resources than they are willing to, thus violating a constraint. In some embodiments, the feasibility constraints may be one or more of event exclusivity, a minimum event profit, a minimum or maximum number of events, a minimum or maximum break duration between events, a minimum or maximum event duration, a minimum or maximum event time, or a constraint related to overlapping events.

The feasibility constraints may check if the current variables are feasible based on the values of the variables at the prior time for a given product-location pair. For example, in determining whether or not an event is not feasible because of overlapping, the method may check to see if both the current variables and the prior variables were running an event and the event would be crossing two distinct time periods, therefore overlapping in time. If so, the node may be fathomed if overlapping events are not allowed. Similarly, the feasibility may check if adding the current node violates the minimum event length (for example, if the current node is a non-event week and is ending a series of time periods in an event) of if it is greater than the maximum event length (for example, if the current node is the continuation of a series of time periods in an event).

Additionally, if both the current variables and the prior variables were not running an event, the node may be fathomed if the break length is greater than the maximum break length or if it is smaller than the minimum break length. Similar feasibility checks may be done for constraints on the total number of events (minimum or maximum), event relationships such as if there is a price discount one must also have an in-store display, price relationships such as price for product A must always be 10% more than price for product B, and other constraints involving the event variables. Otherwise, the node will not be fathomed.

As another example, the method may check whether an event ended and if so, fathom the node if the previous event's profit was below a predetermined minimum event profit. For example, for a given product and location, when the event vector at a certain time is fully decided, if the time is not a first time step in a planning horizon and the time is not the first time step in a given interval, the prior time step is considered. If the event at the last time step is the same as the event at the current time step, then the node is not fathomed due to a minimum profit requirement since the event is still “open”. Otherwise, the event has been “closed” and the node is fathomed if the previous event profit is less than the minimum event profit. In some embodiments, if the child node is determined to be feasible, the method will proceed to step 314.

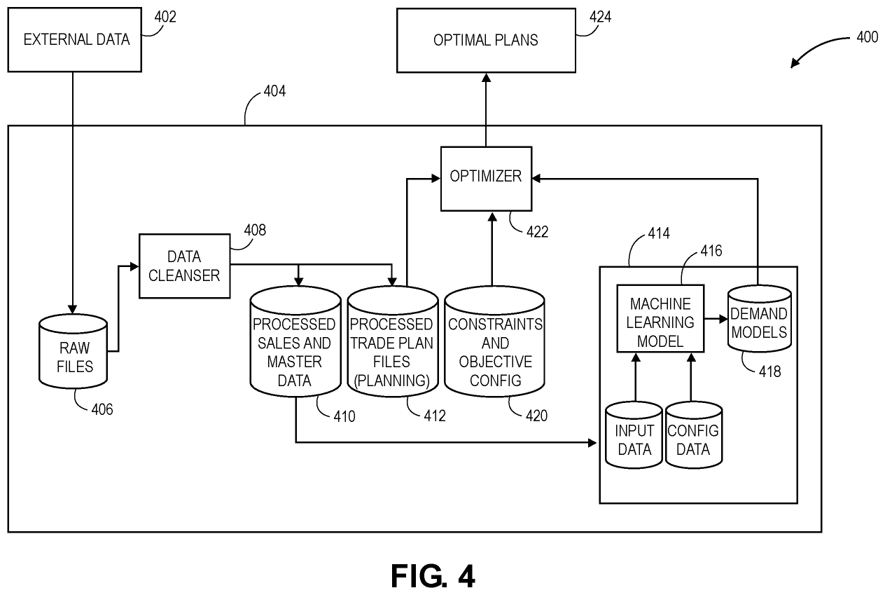

At step 314, it is determined if the upper bounds of the child node are better than the current best feasible solution. An upper bound on the objective is calculated for the node based on the variables at the node. For example, based on the information at the node, the maximum outcome may be calculated given the constraints of the current node. This allows the method to determine the best possible case if the node is expanded, or branched. In some embodiments, calculating the upper bound may involve using a machine-learning model which in part acts to forecast demand based on the constraints at the node. Applying a machine learning model to predict demand is discussed further at FIG. 4 below. In some embodiments, the objective function may be a function of predicted unit sales, such as volume sales, profit, margin, event investments, revenues, or any other relevant objective function. In some embodiments, both upper bounds and lower bounds may be used, with variables either maximizing or minimizing some objective function. If the upper bounds are better, then the child remains a viable candidate and the method proceeds to step 316 such that the child may be added to the stack of remaining nodes to search. Otherwise, if the upper bounds are not better, then the method proceeds to step 318 and the node is discarded. For example, if the node cannot possibly be better than the current best solution, the method has no need to continue to branch on the child, and so the method knows it can save time by discarding it. Once all of the children have been considered and any viable children have been added to the stack, the branching method ends and returns to the main method.

Turning to FIG. 4, an exemplary embodiment is depicted, and referred to generally by reference numeral 400. External data 402 may be supplied to system 404. System 404 may be a computer, server, or any other similar system. In some embodiments, external data 402 may be data related to the outcome of events. For example, external data 402 may be sales data, including historical sales data, initial event plans, historic event plans, or master data. In further embodiments, external data 402 may be received in any format or configuration that may be read or processed by system 404.

In some embodiments, external data 402 may arrive to system 404 as raw files 406. In some embodiments, raw files 406 may need to be processed prior to being used for analysis. Raw files 406 may be reformatted by data cleanser 408. Data cleanser 408 may process the data to make it suitable for analysis. In some embodiments, data cleanser 408 may eliminate duplicate data. In further embodiments, data cleanser 408 may filter and separate data. For example, data cleanser may separate the data into processed sales and master data 410 and processed trade plan files 412. In some embodiments, the processed sales and master data 410 may be sent to machine learning module 414. In some embodiments, the raw files 406 may be received and stored in any suitable data structure.

In some embodiments, machine learning module 414 may use the processed sales and master data 410 along with configuration data as inputs to train machine learning model 416 to forecast demand. In some embodiments, after training machine learning model 416 may generate demand models 418 based on the specific time, products, locations, and events available within the input data. In further embodiments, the machine learning model may use a non-linear regression model fitted with a Bayesian statistical process. In still further embodiments, the machine learning model may be a neural network.

In some embodiments, optimizer 422 receives demand models 418, processed trade plan files 412, and constraints and objective configuration 420. Optimizer 422 may use these inputs to generate optimal plans 424. In some embodiments, optimizer 422 may use a combinatorial branch-and bound method to generate optimal plans 424. While using a combinatorial branch-and bound method, optimizer 422 may use demand models 418 to forecast the expected total value of each possible product, location, time, and event combination. For example, demand models 418 may be used to determine what the outcome would be for a possible timeline of events for product-location pairs. In some embodiments, demand models 418 may include on or more coefficients for seasonality, event parameter elasticity, or and/or any cannibalization effects between similar products.

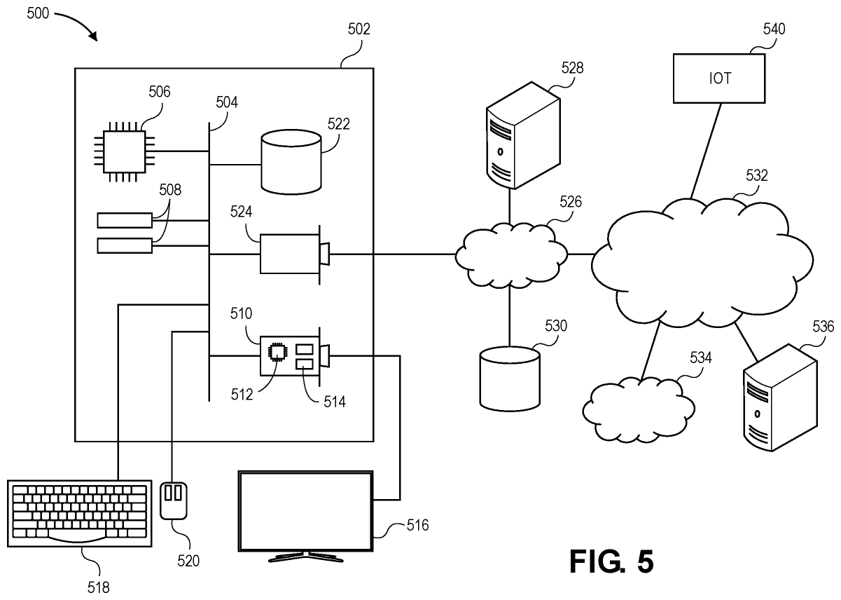

FIG. 5 depicts an exemplary hardware platform that can form one element of certain embodiments of the technology, referred to generally by reference numeral 500. Computer 502 can be a desktop computer, a laptop computer, a server computer, a mobile device such as a smartphone or tablet, or any other form factor of general- or special-purpose computing device. Depicted with computer 502 are several components, for illustrative purposes. In some embodiments, certain components may be arranged differently or absent. Additional components may also be present. Included in computer 502 is system bus 504, whereby other components of computer 502 can communicate with each other. In certain embodiments, there may be multiple busses or components that may communicate with each other directly. Connected to system bus 504 is central processing unit (CPU) 506. Also attached to system bus 504 are one or more random-access memory (RAM) modules 508. The RAM modules 508 may also be integrated into the CPU 506. Also attached to system bus 504 is graphics card 510. In some embodiments, graphics card 510 may not be a physically separate card, but rather may be integrated into the motherboard or the CPU 506. In some embodiments, graphics card 510 has a separate graphics-processing unit (GPU) 512, which can be used for graphics processing or for general purpose computing (GPGPU). Also on graphics card 510 is GPU memory 514. Connected (directly or indirectly) to graphics card 510 is display 516 for user interaction. In some embodiments no display is present, while in others it is integrated into computer 502. Similarly, peripherals such as keyboard 518 and mouse 520 are connected to system bus 504. Like display 516, these peripherals may be integrated into computer 502 or absent. Also connected to system bus 504 is local storage 522, which may be any form of computer-readable media and may be internally installed in computer 502 or externally and removably attached.

Non-transitory computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 524 is also attached to system bus 504 and allows computer 502 to communicate over a network such as network 526. NIC 524 can be any form of network interface known in the art, such as Ethernet, ATM, fiber, Bluetooth, or Wi-Fi (i.e., the IEEE 802.11 family of standards). NIC 524 connects computer 502 to local network 526, which may also include one or more other computers, such as computer 528, and network storage, such as data store 530. Generally, a data store such as data store 530 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 528, accessible on a local network such as local network 526, or remotely accessible over Internet 532. Local network 526 is in turn connected to Internet 532, which connects many networks such as local network 526, remote network 534 or directly attached computers such as computer 536. In some embodiments, computer 502 can itself be directly connected to Internet 532.

Although embodiments have been described with reference to the embodiments illustrated in the attached drawing figures, it is noted that equivalents may be employed and substitutions made herein without departing from the scope as recited in the claims.

Having thus described various embodiments, what is claimed as new and desired to be protected by Letters Patent includes the following:

1. One or more non-transitory computer-readable media storing computer-executable instructions that, when executed by a processor, perform a method for creating an improved timeline of events for product-location pairs, the method comprising:
receiving time series historical data comprising information on a plurality of past products, past locations, past event parameters, past events, and past outcomes of the events;
training a machine learning model to generate a demand forecast based on the historical data;
receiving input requirements comprising:
a set of available time periods;
a set of product-location pairs, wherein each product-location pair includes a set of possible events for the product-location pair and a set of possible event parameters;
an initial timeline of events for the product-location pairs comprising an initial event parameter and an initial one or more events for each product-location pair for each available time period;
an objective function; and
using combinatorial branch-and-bound, generating the improved timeline of events for the product-location pairs by determining, for each available time period, an event parameter and one or more events for each product-location pair such that the improved timeline of events is feasible and maximizes the objective function based on applying the machine learning model to the improved timeline of events.

2. The media of claim 1, wherein the demand forecast includes a seasonality coefficient and an event parameter elasticity coefficient.

3. The media of claim 1, wherein the demand forecast includes cannibalization effects between products.

4. The media of claim 1, wherein the objective function is to maximize a total outcome of the improved timeline of events.

5. The media of claim 1, wherein each product-location pair is assigned to a specific product group.

6. The media of claim 1, wherein it is determined that the improved timeline of events is not feasible when there is not one or more time periods between each event for a product-location pair.

7. The media of claim 1, wherein the input requirements further comprises a minimum number of events for each product and the improved timeline of events is not feasible when there are less than the minimum number of events for each product.

8. A method for creating an improved timeline of events for product-location pairs comprising:
receiving time series historical data comprising information on a plurality of past products, past locations, past event parameters, past events, and past outcomes of the events;
training a machine learning model to generate a demand forecast based on the historical data;
receiving input requirements comprising:
a set of available time periods;
a set of product-location pairs, wherein each product-location pair includes a set of possible events for the product-location pair and a set of possible event parameters for the product-location pair;
an initial timeline of events for the product-location pairs comprising an initial event parameter and an initial one or more events for each product-location pair for each available time period;
an objective function; and
using combinatorial branch-and-bound, generating the improved timeline of events for the product-location pairs by determining, for each available time period, an event parameter and one or more events for each product-location pair such that the improved timeline of events is feasible and maximizes the objective function based on applying the machine learning model to the improved timeline of events.

9. The method of claim 8, wherein the demand forecast includes a seasonality coefficient and an event parameter elasticity coefficient.

10. The method of claim 8, wherein the demand forecast includes cannibalization effects between products.

11. The method of claim 8, wherein the objective function is to maximize a total outcome of the improved timeline of events.

12. The method of claim 8, wherein each product-location pair is assigned to a specific product group.

13. The method of claim 8, wherein the improved timeline of events is not feasible if there is not one or more time periods between each event for a product-location pair.

14. The method of claim 8, wherein the input requirements further comprises a minimum number of events for each product and the improved timeline of events is not feasible if there are less than the minimum number of events for each product.

15. A system comprising at least one data processor and at least one non-transitory memory storing computer executable instructions that when executed by the at least one data processor cause the system to carry out actions comprising:
receiving time series historical data comprising information on a plurality of past products, past locations, past event parameters, past events, and past outcomes of the events;
training a machine learning model to generate a demand forecast based on the historical data;
receiving input requirements comprising:
a set of available time periods;
a set of product-location pairs, wherein each product-location pair includes a set of possible events for the product-location pair and a set of possible event parameters for the product-location pair;
an initial timeline of events for the product-location pairs comprising an initial event parameter and an initial one or more events for each product-location pair for each available time period;
an objective function; and
using combinatorial branch-and-bound, generating an improved timeline of events for the product-location pairs by determining, for each available time period, an event parameter and one or more events for each product-location pair such that the improved timeline of events is feasible and maximizes the objective function based on applying the machine learning model to the improved timeline of events.

16. The system of claim 15, wherein the demand forecast includes a seasonality coefficient and an event parameter elasticity coefficient.

17. The system of claim 15, wherein the demand forecast includes cannibalization effects between products.

18. The system of claim 15, wherein the objective function is to maximize a total outcome of the improved timeline of events.

19. The system of claim 15, wherein each product-location pair is assigned to a specific product group.

20. The system of claim 15, wherein the improved timeline of events is determined to be not feasible when there is not one or more time periods between each event for a product-location pair.
